(19) United States
(12) Patent Application Publication
(10) Pub. No.: US 2014/0195220 A1
(43) Pub. Date: Jul. 10, 2014

(54) METHOD AND SYSTEM FOR INTERNATIONALIZATION OF A COMPUTING DEVICE

(71) Applicants: Penchala Harsha Pachipala, Bangalore (IN); Licy John, Bangalore (IN)

(72) Inventors: Penchala Harsha Pachipala, Bangalore (IN); Licy John, Bangalore (IN)

(73) Assignee: UNISYS CORPORATION, Blue Bell, PA (US)

(21) Appl. No.: 13/847,121

(22) Filed: Mar. 19, 2013

(30) Foreign Application Priority Data
Jan. 7, 2013 (IN) 45/DEL/2013

(51) Int. Cl. G06F 17/28

(52) U.S. Cl. CPC G06F 17/289
USPC 704/8

(57) ABSTRACT

A method for Internationalization of a product in a computing device having a locale. The method includes launching the product on the computing device, determining if a resource bundle for the locale is included in the product, obtaining a resource bundle for the locale from a predetermined location external to the product if the resource bundle for the locale is not included in the product, loading the product on the computing device using the resource bundle for the locale obtained from the predetermined location, and launching the product on the computing device with the locale as the default locale.

### BACKGROUND

1. Field

The instant disclosure relates generally to computing devices, and more particularly, to language support selection of computing devices.

2. Description of the Related Art

Most of today's computing devices, such as personal desktop computers and laptop computers, are able to support and run their operating system in one or more different languages, depending on which languages are supported in the pre-installed operating system or which languages are provided in subsequently installable language support applications. The ability to adapt computer software, including a computer's operating system, to different languages typically is referred to as Internationalization. The ability to support some but not all languages typically is included in the operating system.

For computing devices that are designed to run one or more versions of a Microsoft (MS) Windows operating system, a conventional MS Windows application typically supports Internationalization only for the languages that already are pre-installed with the operating system or other language support software product. The ability for a user of the computing device to select a desired language for the operating system occurs either in an install shield while installing the product or by selecting a specific language from a menu provided in the user interface (UI) of the product. However, should the user desire support for a language that is not already bundled into the product, the product typically has to be re-bundled or re-packaged with the desired language support.

### SUMMARY

Disclosed is a method for Internationalization of a product in a computing device having a locale. The method includes launching the product on the computing device, determining if a resource bundle for the locale is included in the product, obtaining a resource bundle for the locale from a predetermined location external to the product if the resource bundle for the locale is not included in the product, loading the product on the computing device using the resource bundle for the locale obtained from the predetermined location, and launching the product on the computing device with the locale as the default locale.

### BRIEF DESCRIPTION OF THE DRAWINGS

FIG. 1 is a schematic view of a method for internationalization of a computing device, according to an embodiment;

FIG. 2 is a screen shot of a user interface for defining the location from which to obtain a desired resource bundle, according to an embodiment;

FIG. 3 is a screen shot indicating that a resource bundle for a selected language for a computing device is unavailable, according to an embodiment;

FIG. 4 is a screen shot of a user interface for loading a default language for a computing device is the selected language is unavailable, according to an embodiment; and

FIG. 5 is a schematic view of a computing device apparatus for supporting internationalization of any selected language, according to an embodiment.

### DETAILED DESCRIPTION

In the following description, like reference numerals indicate like components to enhance the understanding of the disclosed method and apparatus for providing low latency communication/synchronization between parallel processes through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

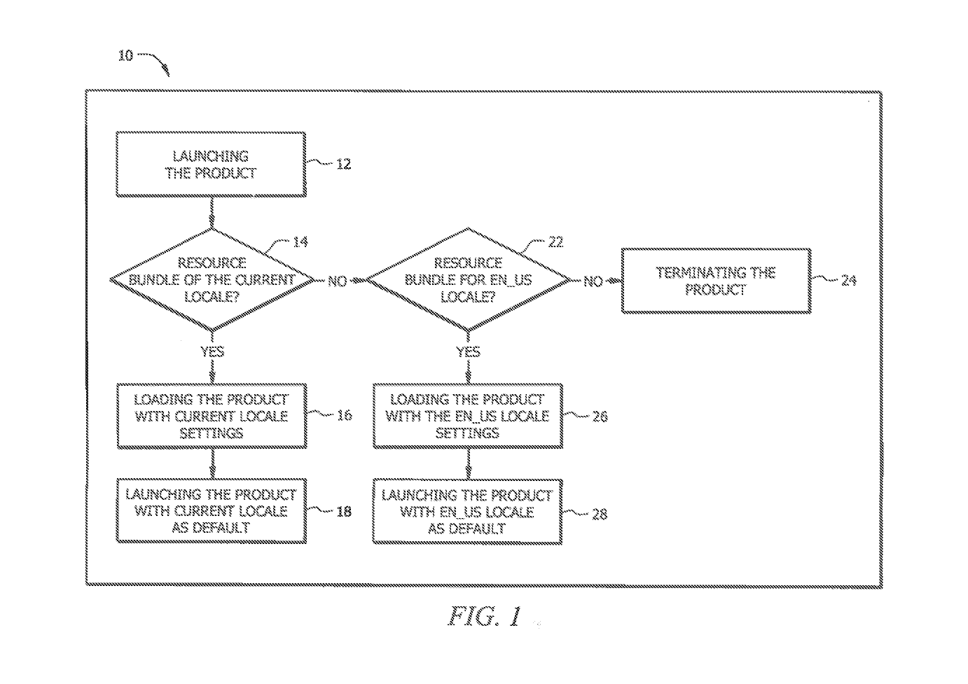

FIG. 1 is a schematic view of a method 10 for Internationalization of a computing device, according to an embodiment. The method 10 provides a relatively user-friendly way of running a product, such as an operating system, with any language settings, without requiring any engineering changes to the product and without requiring an engineering team to bundle and repackage the product to support language settings that may not be included in the original product.

The method 10 includes a step 12 of launching or starting the product. The product can be an operating system or other appropriate product for use on a computing device by a user. As discussed, conventionally, products do not usually contain language support for all possible languages that a user of the computing device may desire.

The method also includes a step 14 of determining whether or not a resource bundle can be obtained for the current locale of the computing device. A resource bundle is a file, typically a Java .properties file. A resource bundle provides a way of Internationalizing a Java or other appropriate application by making the code of the product locale-independent. A locale is a set of parameters that defines the language of the user, the country, and any special variant preferences that the user wants to see in the user interface of the computing device of the user. For example, a locale identifier typically includes at least a language identifier and a region identifier.

Conventionally, products typically include some resource bundles for some locales, but not all possible resource bundles for all possible locales. Therefore, as discussed hereinabove, for a product that does not already include a particular resource bundle, that product must be bundled and re-packaged into the product.

According to an embodiment, the product of interest includes the US English resource bundle as a default resource bundle. Also, according to an embodiment, resource bundles not included in the originally packaged product are obtainable from a predetermined location (external to the product and/or external to the product and the computing device) based on the particular locale of the computing device. The predetermined location can be any suitable location from which the computing system can obtain the necessary resource bundle desired by the user, and typically is locale dependent.

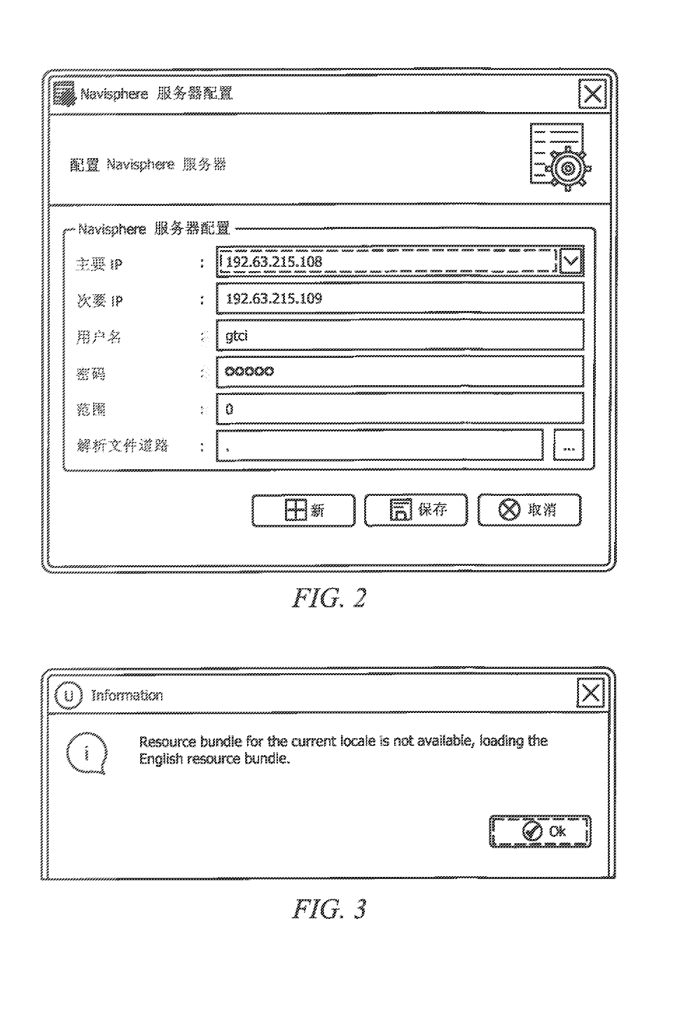

If the determining step 14 determines that a desired resource bundle not otherwise included in the product of interest is obtainable from a predetermined location (Yes), the method 10 includes a step 16 of acquiring and loading the desired resource bundle for use by the product. According to an embodiment, the acquired resource bundle is picked up by reading the locale specific information of the user of the computing device. FIG. 2 is a screen shot of a user interface for defining the location from which to obtain a desired resource bundle, according to an embodiment. For example, if the user's locale is set to support the Chinese language, the user's locale is found and the corresponding resource bundle (Chinese, in this example) is obtained form a predetermined location and loaded onto the computing device for subsequent use by the product.

The method 10 also includes a step 18 of launching the product with the current locale (and corresponding resource bundle) as the default for the computing device. Once the desired resource bundle has been acquired and loaded, the product is launched reading the data from the acquired resource bundle.

In products following a conventional approach, the resource bundle and other associated details are hardwired into the product code. Therefore, every time new support for a language is needed, the product typically has to be re-bundled or re-packaged with the new language support.

In the method 10, web-based applications are applied to overcome this problem by defining a completely different set of pages based on the locale. The method 10 makes use of downloading or copying resource bundles and installing them on the computing device with the product. This approach also reduces or keeps down the overall size of the product compared to the conventional approach. In the conventional approach, the overall size of the product increases with each successive re-bundling or re-packaging.

If the determining step 14 determines that a desired resource bundle not otherwise included in the product of interest is not obtainable from a predetermined location (No), the user is informed that the desired resource bundle is missing or otherwise not available. FIG. 3 is a screen shot indicating that a resource bundle for a selected language for a computing device is unavailable. The method 10 then proceeds to a step 22 of determining whether or not the US English resource bundle can be obtained. As discussed hereinabove, the US English resource bundle typically is included in the product as a default resource bundle. However, if the US English resource bundle is not included in the product as a default resource bundle, or if the US English resource bundle cannot be obtained (No), the method 10 includes a step 24 of terminating the product.

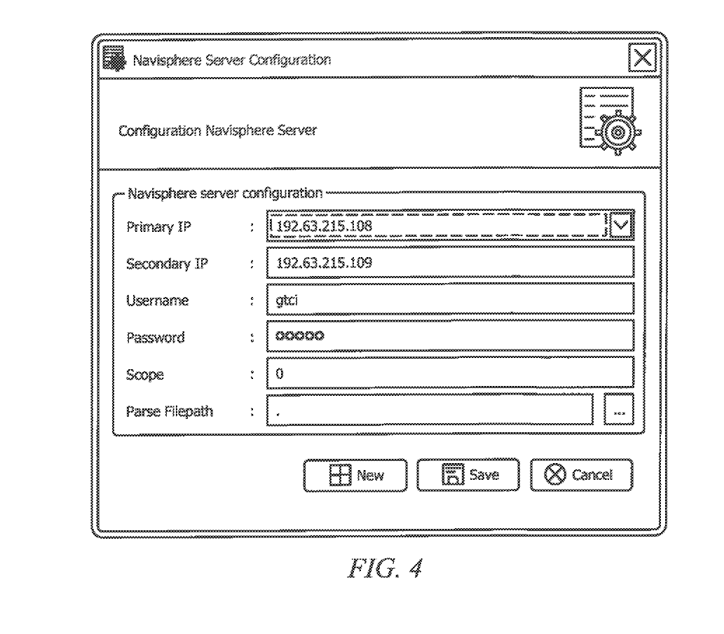

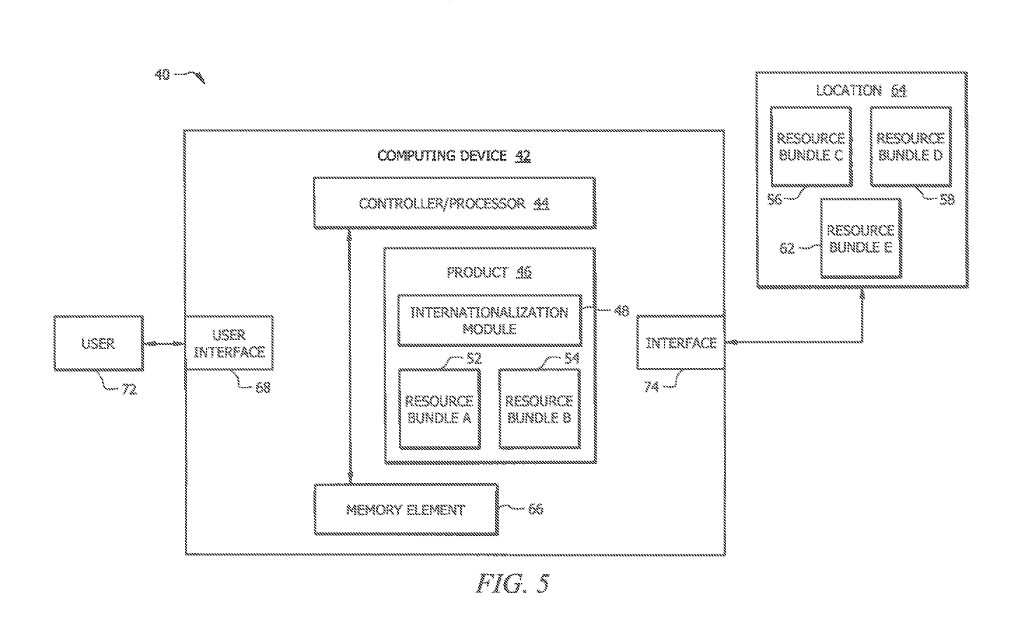

If the determining step 22 determines that the US English resource bundle is available, either from the product or from another location (Yes), the method 10 includes a step 26 of acquiring and loading the US English resource bundle for use by the product. FIG. 3 is a screen shot indicating that a resource bundle for a selected language for a computing device is unavailable, and that the US English resource bundle is being loaded. FIG. 4 is a screen shot of a user interface for loading a default language resource bundle, e.g., the US English language resource bundle, according to an embodiment.

The method 10 also includes a step 28 of launching the product with the en_US locale (and the corresponding US English resource bundle) as the default for the computing device. Once the US English resource bundle has been acquired and loaded, the product is started (or re-started) with the en_US locale (and the corresponding US English resource bundle) as the default for the computing device.

FIG. 5 is a schematic view 40 of a computing device apparatus 42 for supporting internationalization of any selected language, according to an embodiment. The computing device 42 can be any suitable device that is able to support and run an operating system in one or more different languages. For example, the computing device 42 can be a desktop computer, a laptop computer, or other suitable computing device.

The computing device 42 includes one or more general purpose (host) controllers or processors 44 that, in general, processes instructions, data and other information received by the computing device 42. The processor 44 also manages the movement of various instructional or informational flows between various components within the computing device 42. The processor 44 includes a product 46, such as an operating system, has an Internationalization or language support module 48 that is configured to execute and perform the Internationalization and language support methods described herein.

As discussed hereinabove, the product 46 may have resource bundles for supporting various languages, such as a first resource bundle A 52 and a second resource bundle B 54, pre-installed as part of the product 46. However, as discussed hereinabove, the product 46 typically does not have all desired resource bundles for supporting all desired languages. According to an embodiment, one or more of the resource bundles not pre-installed in the product 46, such as a resource bundle C 56, a resource bundle D 58, and a resource bundle E 62, can be subsequently acquired from a predetermined location 64 external to the computing device 42.

The computing device 42 also can include a memory element or content storage element 66, coupled to the processor 44, for storing instructions, data and other information received and/or created by the computing device 42. In addition to the memory element 66, the computing device 42 can include at least one type of memory or memory unit (not shown) within the processor 44 for storing processing instructions and/or information received and/or created by the computing device 42.

The computing device 42 also can include one or more user interfaces 68 for receiving instructions, data and other information from a user 72. The computing device 42 also can include one or more interfaces 74 for receiving resource bundles and other data and information from a predetermined location 64. It should be understood that one or both of the user interface 68 and the interface 74 can be a single input/output interface, or the computing device 42 can include separate input and output interfaces (as shown).

One or more of the processor 44, the product 46, the Internationalization or language support module 48, the memory element 66 and the interfaces 68, 74 can be comprised partially or completely of any suitable structure or arrangement, e.g., one or more integrated circuits. Also, it should be understood that the computing device 42 includes other components, hardware and software (not shown) that are used for the operation of other features and functions of the system 40 not specifically described herein.

The computing device 42 can be partially or completely configured in the form of hardware circuitry and/or other hardware components within a larger device or group of components. Alternatively, the processes performed by the computing device 42 can be partially or completely configured in the form of software, e.g., as processing instructions and/or one or more sets of logic or computer code. In such configuration, the logic or processing instructions typically are stored in a data storage device, e.g., the memory element 66 or other suitable data storage device (not shown). The data storage device typically is coupled to a processor or controller, e.g., the processor 44. The processor accesses the necessary instructions from the data storage element and executes the instructions or transfers the instructions to the appropriate location within the computing device 42.

One or more of the Internationalization or language support module 48 can be implemented in software, hardware, firmware, or any combination thereof. In certain embodiments, the module(s) may be implemented in software or firmware that is stored in a memory and/or associated components and that are executed by the processor 44, or any other processor(s) or suitable instruction execution system. In software or firmware embodiments, the logic may be written in any suitable computer language. One of ordinary skill in the art will appreciate that any process or method descriptions associated with the Internationalization or language support module 48 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

One or more of the controller and processor can be comprised partially or completely of any suitable structure or arrangement, e.g., one or more integrated circuits. Also, it should be understood that the computing device shown include other components, hardware and software (not shown) that are used for the operation of other features and functions of the computing devices not specifically described herein.

The functions described herein may be implemented in hardware, software, firmware, or any combination thereof. If implemented in software, the functions may be stored on or transmitted as one or more instructions or code on a non-transitory computer-readable medium. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for Internationalization of a product in a computing device, the computing device having a locale, comprising:
launching the product on the computing device;
determining if a resource bundle for the locale is included in the product;
if the resource bundle for the locale is not included in the product, obtaining the resource bundle for the locale from a predetermined location external to the product;
loading the product on the computing device using the resource bundle for the locale obtained from the predetermined location; and
launching the product on the computing device reading the data from the resource bundle for the locale obtained from the predetermined location.

2. The method as recited in claim 1, wherein the product includes a US English language resource bundle, and wherein the method includes loading the product on the computing device using the US English language resource bundle if the resource bundle for the locale cannot be obtained from the predetermined location.

3. The method as recited in claim 1, wherein loading the product on the computing device using the resource bundle for the locale obtained from the predetermined location is performed without bundling and re-packaging the product with the resource bundle for the locale obtained from the predetermined location bundled.

4. The method as recited in claim 1, wherein the resource bundle for the locale is obtained from the predetermined location by reading locale specific information provided to the computing device.

5. The method as recited in claim 1, wherein loading the product on the computing device using the resource bundle for the locale obtained from the predetermined location is performed in such a way that language settings associated with the locale are supported by the computing device.

6. The method as recited in claim 1, wherein the locale is a user-selected locale.

7. The method as recited in claim 1, wherein the predetermined location is external to the computing device.

8. The method as recited in claim 1, wherein the product is an operating system.

9. A computing device, comprising:
a processor;
a user interface coupled to the processor for providing to the computing device a locale; and
a product loaded on the computing device, wherein the product includes an Internationalization module configured to provide Internationalization and language support to the computing device,
wherein the processor is configured to launching the product on the computing device,
wherein the Internationalization module is configured to determine if a resource bundle for the locale is included in the product,
wherein the Internationalization module is configured to obtain a resource bundle for the locale from a predetermined location external to the product if the resource bundle for the locale is not included in the product,
wherein the processor is configured to load the product on the computing device using the resource bundle for the locale obtained from the predetermined location,
wherein the processor is configured to start the product on the computing device reading the data from the resource bundle for the locale obtained from the predetermined location.

10. The computing device as recited in claim 9, wherein the product includes a US English language resource bundle, and wherein the processor is configured to load the product on the computing device using the US English language resource bundle if the resource bundle for the locale cannot be obtained from the predetermined location.

11. The computing device as recited in claim 9, wherein the processor is configured to load the product on the computing device using the resource bundle for the locale obtained from the predetermined location without bundling and re-packaging the product with the resource bundle for the locale obtained from the predetermined location bundled.

12. The computing device as recited in claim 9, wherein the Internationalization module is configured to obtain the resource bundle for the locale from the predetermined location by reading locale specific information provided to the computing device.

13. The computing device as recited in claim 9, wherein the processor is configured to load the product on the computing device using the resource bundle for the locale obtained from the predetermined location in such a way that language settings associated with the locale are supported by the computing device.

14. The computing device as recited in claim 9, wherein the locale is a user-selected locale.

15. The computing device as recited in claim 9, wherein the predetermined location is external to the computing device.

16. The computing device as recited in claim 9, wherein the product is an operating system.

17. A non-transitory computer readable medium having instructions stored thereon which, when executed by a processor, carry out a method for Internationalization of a product in a computing device, the computing device having a locale, comprising:
instructions for launching the product on the computing device;
instructions for determining if a resource bundle for the locale is included in the product;
instructions for obtaining the resource bundle for the locale from a predetermined location external to the product if the resource bundle for the locale is not included in the product;
instructions for loading the product on the computing device using the resource bundle for the locale obtained from the predetermined location; and
instructions for launching the product on the computing device reading the data from the resource bundle for the locale obtained from the predetermined location.

18. The non-transitory computer readable medium as recited in claim 17, wherein the product includes a US English language resource bundle, and wherein the non-transitory computer readable medium includes instructions for loading the product on the computing device using the US English language resource bundle if the resource bundle for the locale cannot be obtained from the predetermined location.

19. The non-transitory computer readable medium as recited in claim 17, wherein instructions for loading the product on the computing device using the resource bundle for the locale obtained from the predetermined location are performed without bundling and re-packaging the product with the resource bundle for the locale obtained from the predetermined location bundled.

20. The non-transitory computer readable medium as recited in claim 17, wherein instructions for loading the product on the computing device using the resource bundle for the locale obtained from the predetermined location are performed in such a way that language settings associated with the locale are supported by the computing device.
